(19) United States
(12) Patent Application Publication
(10) Pub. No.: US 2015/0324333 A1
(43) Pub. Date: Nov. 12, 2015

(54) SYSTEMS AND METHODS FOR AUTOMATICALLY GENERATING HYPERLINKS

(71) Applicant: Level 3 Communications, LLC, Broomfield, CO (US)

(72) Inventor: Gregg Wallace Squires, Superior, CO (US)

(73) Assignee: Level 3 Communications, LLC, Broomfield, CO (US)

(21) Appl. No.: 14/270,515

(22) Filed: May 6, 2014

(51) Int. Cl. G06F 17/22; G06F 17/21; G06F 17/30

(52) U.S. Cl. CPC G06F 17/2235; G06F 17/30882; G06F 17/211

(57) ABSTRACT

Aspects of the present disclosure include systems and methods for the automatic generation of hyperlinks. One or more objects may be identified from a stream of text obtained from one or more systems. The objects may be wrapped in a hyperlink and provided for display, such as within a web page accessible via the Internet.

### TECHNICAL FIELD

Aspects of the present disclosure relate to data resources, and in particular, to the automatic generation of hyperlinks.

### BACKGROUND

The World Wide Web (the “web”) has experienced dramatic growth in recent years, and has transformed the Internet from a primarily passive environment used for email, newsgroups and mailing lists, to an interactive universe filled with vast amounts of information. Due to the large amount of available information, there is a need for efficient methods of associating web pages with each other and the use of hyperlinks have become critical in enabling such connectivity. Generally speaking, a hyperlink is a reference to information that when selected, connects the user's browser to a network location, such as a web page or document. For example, hyperlinks are commonly displayed on web pages accessible through a communication network such as the Internet. A typical web page may include dozens of hyperlinks, each of which may be used to connect a user to relevant content, data, and other web pages.

Conventional methods for developing hyperlinks often involve hand-coding (i.e. manual code writing by a programmer), such as manual insertion of the hyperlink into a markup language document by a programmer, which may be time-consuming, labor intensive, and expensive. Moreover, static hyperlinks are often error-prone, unable to respond to changes in website architecture and business rules. It is with these problems in mind, among others, that various aspects of the present disclosure were conceived.

### SUMMARY

Aspects of the present disclosure involve systems for generating hyperlinks. The system includes at least one processor. The at least one processor is configured to receive a stream of text from a network system corresponding to a telecommunication service provider. The at least one processor is further configured to process the stream of text to extract at least one text-token and determine whether an object may be recognized from the at least one text-token. The at least one processor is configured to generate a hyperlink associated with the at least one text-token when the object is recognized by wrapping the at least one text-token according to a particular format.

Other aspects of the present disclosure include methods for generating hyperlinks. The method is executable by at least one processor. The methods includes receiving a stream of text from a network system corresponding to a telecommunication service provider. The method further includes processing the stream of text to extract at least one text-token. The method includes determining whether an object may be recognized from the at least one text-token. The method includes generating a hyperlink associated with the at least one text-token when the object is recognized by wrapping the at least one text-token according to a particular format.

Aspects of the present disclosure involve non-transitory computer-readable mediums encoded with instructions for generating hyperlinks. The instructions are executable by a processor. The instructions include receiving a stream of text from a network system corresponding to a telecommunication service provider. The instructions further include processing the stream of text to extract at least one text-token. The instructions include determining whether an object may be recognized from the at least one text-token. The instructions include generating a hyperlink associated with the at least one text-token when the object is recognized by wrapping the at least one text-token according to a particular format.

### BRIEF DESCRIPTION OF THE DRAWINGS

The foregoing and other objects, features, and advantages of the present disclosure set forth herein will be apparent from the following description of particular embodiments of those inventive concepts, as illustrated in the accompanying drawings. It should be noted that the drawings are not necessarily to scale; however, the emphasis instead is being placed on illustrating the principles of the inventive concepts. Also, in the drawings the like reference characters refer to the same parts throughout the different views. The drawings depict only typical embodiments of the present disclosure and, therefore, are not to be considered limiting in scope.

FIG. 1 is a flowchart illustrating an example process for automatically generating hyperlinks, according to aspects of the present disclosure.

FIG. 2 is block diagram illustrating a computing environment for automatically generating hyperlinks, according to aspects of the present disclosure.

FIGS. 3A-3B are block diagrams illustrating objects, according to aspects of the present disclosure.

FIG. 4 is a diagram of a computing system, according to aspects of the present disclosure.

### DETAILED DESCRIPTION

Aspects of the present disclosure describe systems and methods for automatically generating hyperlinks from a stream of text. In various aspects, streams of text received from various output sources, such as text received in the output from an application, applet, document, network, image, and/or the like, may be processed to extract or otherwise identify text-tokens capable of being recognized as one or more abstract objects. Generally speaking, an “object” is a data structure containing information and/or data about the object itself and optionally one or more actions capable of manipulating the data. Recognizing objects from extracted text-tokens enables the various systems described herein to delineate between the portions of text in the text stream that should be hyperlinked and the portions of text that should not. For example, when an object is recognized from a particular text-token extracted from the text-stream, the particular text-token may be wrapped or otherwise associated with a hyperlink according to various formats and provided for display, such as for example, within a web page being served to a user at a client device.

A hyperlink represents a reference to data, such as a word, string, image, etc., that a user may directly follow, or that is followed automatically. Hyperlinks are commonly found in the definition of a markup document. For example, hyperlink code may be defined in a markup document according to a specific markup language specification, such as hypertext markup language (“HTML”), Extensible markup language (“XML”), and the like. It is contemplated that any type of code capable of isolating a portion of data as a hyperlink may be used.

A user may access or engage a hyperlink displayed on a web page by clicking on a highlighted word or image in which the hyperlink is wrapped or associated. More specifically, when a user accesses or engages the hyperlink, a programmatic command associated with the hyperlink provides access to the target web page, document, content, and/or the like. Although hyperlinks have become a common-place mechanism for providing efficient access to information in a variety of industries, hyperlinks are typically hand-coded and statically placed for display, such as for example on a web page, which makes the creation and deployment of hyperlinks time-consuming and expensive.

The use of hyperlinks are thus often disregarded for the presentation and display of information in situations in which massive amounts of data and/or content is accessible. Stated differently, in situations where large amounts of data and/or content may be accessed by a user, hand-coding numerous individual hyperlinks to access various portions of the data may be inefficient. Moreover, often times, the information will change, requiring any hyperlinks associated with the data to change. For example, in the context of the telecommunications industry, various computing resources, such as infrastructures, applications, file systems, databases, and the like, are commonly used to monitor a telecommunication service provider's network and the millions of devices currently active within the network. Typically, such systems are complex and archaic, produce massive amounts of changing data output, and require manual interactions from highly skilled developers and/or administrators to extract and provide any relevant data that may be used in identifying potential networks issues. The use of manually created hyperlinks to provide access to such output and/or data would only exacerbate the complexities of such systems because, in addition to manually extracting any relevant output, the developers and/or administrators would have to hand-code hundreds of hyperlinks to provide access to the large amounts of output and/or data. Aspects of the present disclosure enable the automatic generation of hyperlinks that may be automatically integrated within the output generated by such systems.

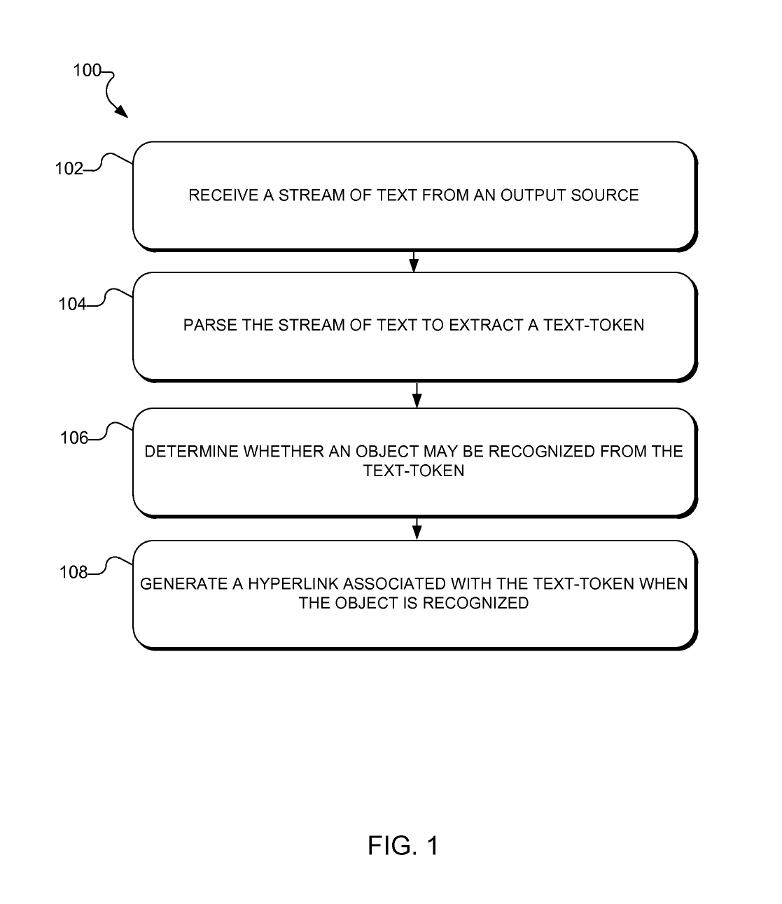

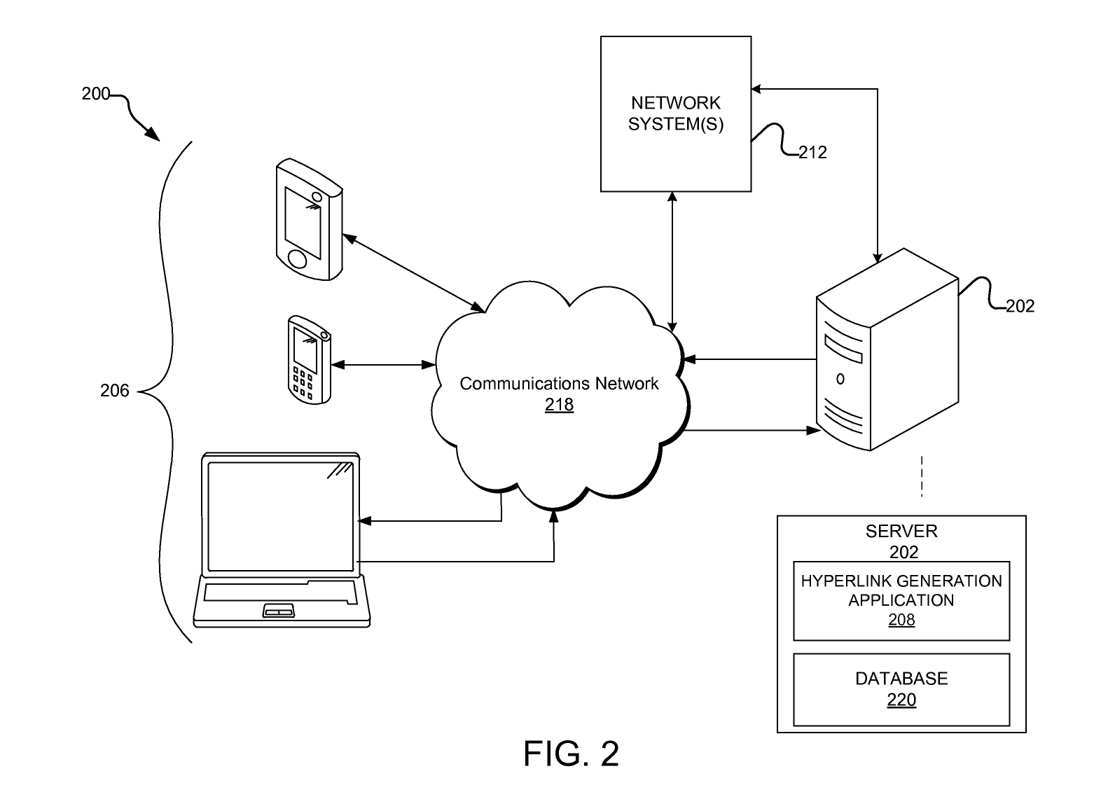

An illustrative process and system for automatically generating hyperlinks, is depicted in FIGS. 1-2. In particular, FIG. 1 illustrates an example process 100 for automatically generating hyperlinks. FIG. 2 illustrates a computing environment 200 including a server 202 configured to generate the various hyperlinks. More specifically, FIG. 2 illustrates a computing environment 200 including a server 202 operating in conjunction with various other hardware and/or software components that may be used to perform or otherwise execute the process 100.

Referring now to FIG. 1, process 100 begins with receiving a stream of text from an output source (operation 102). The stream of text may be any stream of text, whether from legacy fixed-pitch output sources (e.g. terminals, tty oriented application output) or variable pitch formatted text, and may be received from any type of processing device capable of producing text, textual data, images, and/or documents containing text and/or text data. Fixed-pitch text includes text or font in which the letters and characters each occupy the same amount of horizontal space. In contrast, a variable-pitched formatted text includes text where the letters and characters differ in size from one another. The documents may be of various types, such as conventional text documents, Portable Document Format (PDF) documents, PowerPoint presentations, Word documents, Excel documents, HTML or there markup language documents, postscript documents, multimedia documents, and the like. In one embodiment, as illustrated in FIG. 2, the stream of text may be received from a network system 212 configured to monitor, access, and/or otherwise maintain various aspects of a telecommunications network. Thus, the text data may include network monitoring data, information, textual output, and/or other data describing various metrics, aspects, or characteristics of a telecommunications network capable of being monitored.

The stream of text may be received by the server 202, which may be a personal computer, work station, server, mobile device, mobile phone, processor, and/or other type of processing device and may include one or more processors that process software or other machine-readable instructions. The server 202 may further include a memory to store the software or other machine-readable instructions and data and a communication system to communicate via a wireline and/or wireless communications, such as through the Internet, an Intranet, and Ethernet network, a wireline network, a wireless network, and/or another communication network.

Referring again to FIG. 1, the text data may be parsed and/or processed to extract one or more text-tokens (operation 104). As illustrated in FIG. 2, the server 202 may provide a process and/or algorithm capable of identifying discrete/related elements of the received text stream. For example, the hyperlink generation application 208 of the server 202 may include a tokenizing process and/or tokenizer that delineates between white space and words, phrases, symbols, or other elements, generally referred as “text-tokens.” Thus, the tokenizing process may separate or disassemble the white-space included within the received stream of text from text-tokens (text strings bound by whitespace). The white space may be stored or otherwise maintained in an array and any identified text-tokens may be stored in a separate array, or other type of data structure. While the above examples refer to a tokening process, it is contemplated any suitable algorithm and/or process capable of identifying text-tokens may be used to separate the text-tokens from white space included in the received stream of text.

Referring again to FIG. 1, each identified text-token may be processed to recognize an object (operation 106). More specifically, the array containing each of the identified text-tokens may be iterated and each text-token stored within the array may be passed to an object recognizer process of the hyperlink generation application 208 that recognizes text-tokens as a particular object. As defined above, an object represents a unique item or entity that contains data and each object may include or otherwise be associated with an operation known as a default “action.” An action describes a function the object may be capable of performing and/or specific data or information the object may be configured to output.

An example process for recognizing text objects that are to be hyperlinked will now be provided. Assume a data stream containing potential objects for hyperlinking is received or otherwise obtained and objects are parsed from the stream. Often, such objects will be strings of text characters bounded by “whitespace” (characters with lexical, semantic, or syntactic properties of the space (“ ”) character). In this example, an “object dictionary” (the concept of an object dictionary will be described in further detail below) is maintained that includes a collection of subroutines. Each subroutine accepts a pointer to the object that has been parsed in the previous step. Each subroutine is called in turn to try the object to see if it is a match. Since it is possible that an “object” being examined will match more than one definition in the object dictionary, matches must be tallied, and if there is more than one, a subroutine is called to disambiguate, or choose the best match. Once the best match (if any) is determined, the corresponding routine for the object is called to wrap the object with HTML (or other notation) to create a hyperlink. The hyperlink is created by calling a separate hyperlink generation subroutine that is also included within the object dictionary. Subsequently, the process loops back to pick up the next object to be examined.

In the context of the telecommunications industry, objects may include network-related abstracted objects, such as for example, e-mail addresses, contact phone numbers, customer names, Internet Protocol version 4 addresses, Internet Protocol version 6 addresses, autonomous system numbers, internet protocol address blocks, route policies, filter policies, router names, router interfaces, gateway locations, an interface, etc. It is contemplated that any type of clearly definable network object may be identified that articulates or otherwise provides information corresponding to a telecommunication network.

Other objects include customer ticket numbers objects, process ticket numbers objects, serial numbers objects, and/or arbitrary strings of data architected to link systems to the dynamic hyperlinking process, among others. The last object type implies that once the hyperlinking technique is in place and in common use in the organization, existing systems (applications, databases) can be altered to enhance the dynamic hyperlinking environment or ecosphere of cooperating systems. In cases where such a technique is used throughout the workflow of business, unique identifiers for specific objects in the workflow can be defined specifically for the purpose of object recognition.

As an example, if the object were an email address, the default action corresponding to the action may be to open an email so that a message may be composed and sent. If the object were a phone number, the corresponding default action may be to initiate a phone number. In yet another example, if the object were a customer name, the associated default action may be to display any autonomous system numbers corresponding to the customer. If the object were an autonomous system number, then the default action may be to display any network interfaces associated with the autonomous system number and display various options for access to additional information, such as: any blocked routes and/or allowed routes.

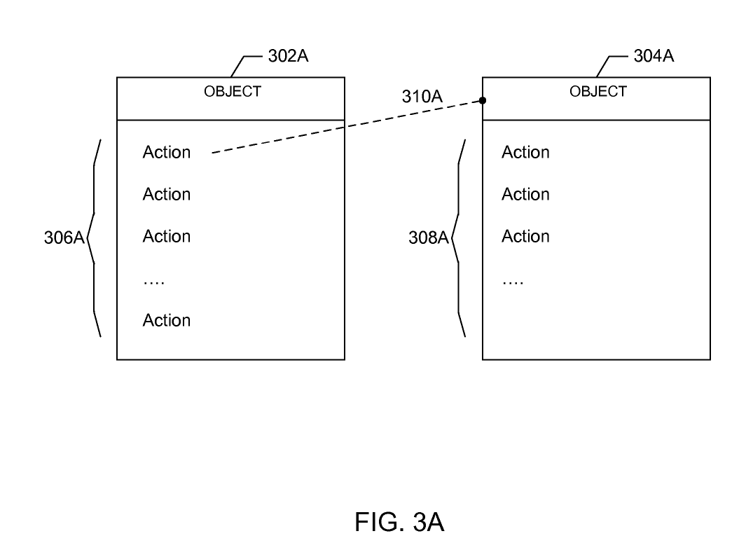

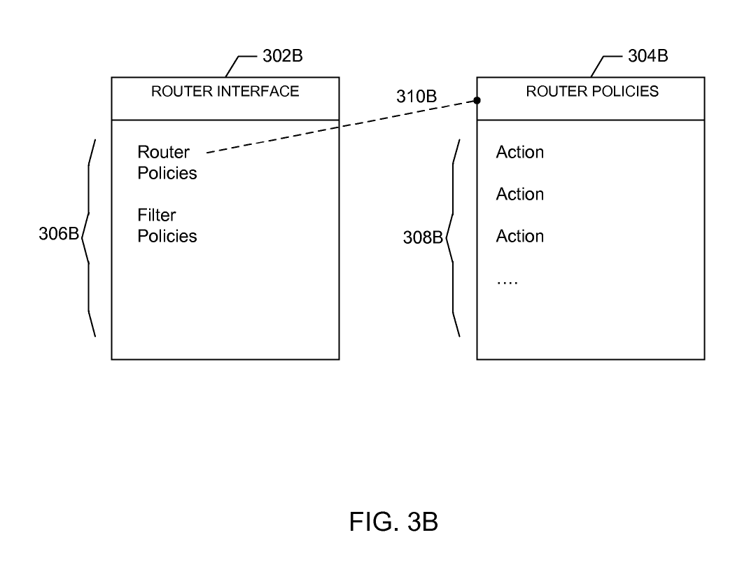

FIG. 3A provides an example illustration of an object 302A and an object 304A. As illustrated, the object 302A includes and/or is otherwise associated with one or more actions 306A. In one embodiment, the object action may be associated with one or more other objects. Thus, as illustrated, the object 304A may be referenced by and/or included within the list of actions 306A of the object 302A, effectively linking such objects, as illustrated by 310A.

FIG. 3B is an illustration of the objects 302B and 304B in the context of a telecommunication service provider requesting access to information related to its network, such as monitoring information. More particularly, assume a telecommunication service provider is capable of monitoring the status of routers within its network. As illustrated in FIG. 3B, the object 302B corresponds to a router interface that includes a router policy action and a filter policies action 306B. In the illustrated example, the route policies action of the router interface object 302B corresponds to the route policies object 304B, which includes one or more of its own actions 308B. In particular, the route policy object 304B may be linked to a URL that displays the general attributes of the route policy. Many of those attributes are in turn objects recognized as objects that can be dynamically hyperlinked, such as: Owner, Maintaine, NETBLK (Network Address Block), Date/Time, Serial Number/Transaction Number, and the like. The objects corresponding to the route policy may be used, for example, as an argument/parameter to a routine that returns a specific policy in the form of text string containing elements such as those above. The text string may be input to the dynamic hyperlinking software (e.g. the hyperlink generation application 208) and the results may be used to populate an HTML table on a web page. The result is that within the table recognized objects are hyperlinked.

The objects and any corresponding default actions may be stored within a database 210 of the server 202, generally referred to as an object “dictionary” or object “repository” that is configured to manage and maintain object data and/or any other object related data. The database may include memory and one or more processors or processing systems to receive, process, query and transmit communications and store and retrieve such data. In another aspect, the database may be a database server. Thus, referring back to FIG. 1 (operation 106), each identified text-token may be processed in an attempt to recognize a particular object currently defined within the “object” dictionary.

Referring again to FIG. 1, if an object is recognized from the particular text-token being processed, the object is used to generate a hyperlink (operation 108). More particularly, when the object is recognized, the particular text-token corresponding to the recognized object (i.e. the text-token from which the object was recognized) is wrapped with an appropriate hyperlink. For example, in one embodiment, the text-token may be wrapped in-place while retaining the formatting in fixed-pitch textual data. Alternatively, the text-token may be wrapped in-place in variable-pitch formatted textual data. Generally speaking, “wrapping” the token refers to prepending and appending the characters necessary to hyperlink the token. For example, to wrap the telephone number “212-555-1212” in HTML, anchor HTML code is pre-pended with “<a href=‘http://foobar.com/destinationpage.php’>”, which is then followed with the object string. Finally, the code “</a>” is included to append the anchor HTML code, which closes the hyperlink anchor.

In a variable-fixed pitch scheme, text strings are separated by whitespace. What whitespace characters are present, and how many, are irrelevant (in general), and in the output stream, test strings are separated by one space. This default behavior produces desired results in prose, but may require the insertion of formatting tags where the test stream is not prose. Wrapping text tokens in this environment has no effect on how the text is rendered.

In fixed pitch formatting, all characters, punctuation, and displayable characters have the same width. In this case “space matters” as three space characters will display the same as three “X” characters. In the case of HTML documents, fixed pitch text is specified using the <pre> and </pre> tags. Text enclosed with these tags will be displayed as fixed pitch, and “space matters” in that formatting through the use of spaces will be displayed, or preserved. Any HTML tags within the text will be recognized and processed without taking up “space” in the text display. Therefore, to preserve fixed pitch text while adding hyperlinks, when the objects in the text stream are parsed, whitespace (or similar formatting elements) must be saved. The objects are processed and possibly wrapped with HTML hyperlinks. The saved formatting information is then re-inserted between the objects in the output stream, thereby preserving the fixed pitch formatting.

If an object is not recognized, then the particular text-token being processed may not be wrapped within a hyperlink or associated with a hyperlink. All of the hyperlinked text-tokens are re-stored within the same array location in which they were initially stored. Subsequently, the decomposed text stream may be reconstructed by iterating though both the array storing the white space and the token array including the newly hyperlinked text-token to reassemble the text stream with formatting in-place and with text-tokens hyperlinked, if appropriate.

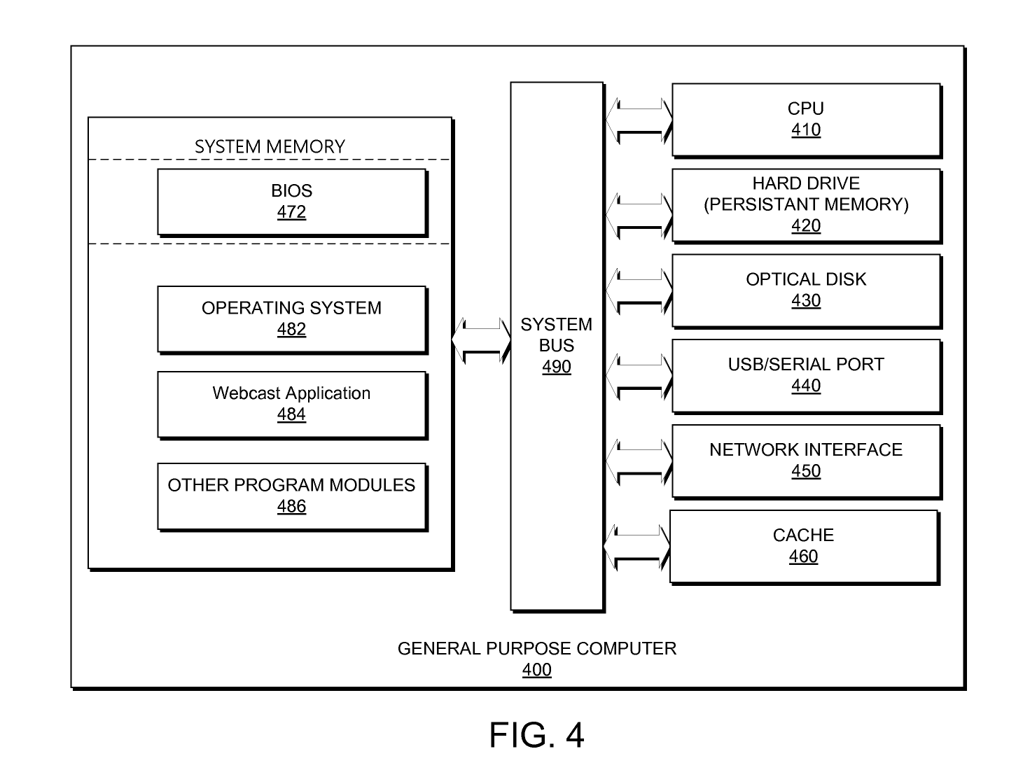

FIG. 4 illustrates an example general purpose computer 400 that may be useful in implementing the described systems (e.g. the server 202). The example hardware and operating environment of FIG. 4 for implementing the described technology includes a computing device, such as general purpose computing device in the form of a personal computer, server, or other type of computing device. In the implementation of FIG. 4, for example, the general purpose computer 400 includes a processor 410, a cache 460, a system memory 420 and a system bus 490 that operatively couples various system components including the cache 460 and the system memory 420 to the processor 410. There may be only one or there may be more than one processor 410, such that the processor of the general purpose computer 400 comprises a single central processing unit (CPU), or a plurality of processing units, commonly referred to as a parallel processing environment. The general purpose computer 400 may be a conventional computer, a distributed computer, or any other type of computer; the disclosure included herein is not so limited.

The system bus 490 may be any of several types of bus structures including a memory bus or memory controller, a peripheral bus, a switched fabric, point-to-point connections, and a local bus using any of a variety of bus architectures. The system memory may also be referred to as simply the memory, and includes read only memory (ROM) and random access memory (RAM). A basic input/output system (BIOS), containing the basic routines that help to transfer information between elements within the general purpose computer 400 such as during start-up may be stored in ROM. The general purpose computer 400 further includes a hard disk drive 420 for reading from and writing to a persistent memory such as a hard disk, not shown and an optical disk drive 430 for reading from or writing to a removable optical disk such as a CD ROM, DVD, or other optical medium.

The hard disk drive 420 and optical disk drive 430 are connected to the system bus 490. The drives and their associated computer-readable medium provide nonvolatile storage of computer-readable instructions, data structures, program engines and other data for the general purpose computer 400. It should be appreciated by those skilled in the art that any type of computer-readable medium which can store data that is accessible by a computer, such as magnetic cassettes, flash memory cards, digital video disks, random access memories (RAMs), read only memories (ROMs), and the like, may be used in the example operating environment.

A number of program engines may be stored on the hard disk, optical disk, or elsewhere, including an operating system 482, an application 484, and one or more other application programs 486. A user may enter commands and information into the general purpose computer 400 through input devices such as a keyboard and pointing device connected to the USB or Serial Port 440. These and other input devices are often connected to the processor 410 through the USB or serial port interface 440 that is coupled to the system bus 490, but may be connected by other interfaces, such as a parallel port. A monitor or other type of display device may also be connected to the system bus 490 via an interface (not shown). In addition to the monitor, computers typically include other peripheral output devices (not shown), such as speakers and printers.

As discussed herein embodiments of the present disclosure include various steps or operations which may be performed by hardware components, software components or, in alternative embodiment, hardware components may be used in combination with the software instructions. Accordingly, aspects of the present disclosure may involve a computing device or system with at least one processor, a system interface, a memory, a storage device and at least one I/O device. The system may further include a processor bus and an input/output (I/O) bus. These and other features may or may not be included in a particular computing system, may be rearranged, and the like.

The memory typically includes one or more memory cards and control circuit, and may further include a main memory and a read only memory (ROM). According to one embodiment, the above methods may be performed by the computer system in response to the processor executing one or more sequences of one or more instructions contained in the main memory. These instructions may be read into main memory from another machine-readable medium capable of storing or transmitting information in a form (e.g., software, processing application) readable by a machine (e.g., a computer). Execution of the sequences of instructions contained in main memory may cause the processor to perform the process steps described herein.

A machine-readable media may take the form of, but is not limited to, non-volatile media and volatile media. Non-volatile media may include a mass storage device and volatile media may include dynamic storage devices. Common forms of machine-readable medium may include, but is not limited to, magnetic storage medium (e.g. floppy diskette); optical storage medium (e.g. CD-ROM), magneto-optical storage medium; read only memory (ROM); random access memory (RAM); erasable programmable memory (e.g., EPROM and EEPROM); flash memory; or other types of medium suitable for storing computer instructions.

Embodiments of the present disclosure include various steps, which are described in this specification. As discussed above, the steps may be performed by hardware components or may be embodied in machine-executable instructions, which may be used to cause a general-purpose or special-purpose processor programmed with the instructions to perform the steps. Alternatively, the steps may be performed by a combination of hardware, software and/or firmware.

While the present disclosure has been described with reference to various embodiments, it will be understood that these embodiments are illustrative and that the scope of the disclosure is not limited to them. Various modifications and additions can be made to the exemplary embodiments discussed without departing from the scope of the present disclosure. For example, while the embodiments described above refer to particular features, the scope of this disclosure also includes embodiments having different combinations of features and embodiments that do not include all of the described features. Accordingly, the scope of the present disclosure is intended to embrace all such alternative, modifications, and variations together with all equivalents thereof.

What is claimed is:

1. A method for generating hyperlinks comprising:
receiving, at at least one processor, a stream of text from a network system corresponding to a telecommunication service provider;
processing the stream of text to extract at least one text-token;
determining, at the at least one processor, whether an object may be recognized from the at least one text-token; and
generating a hyperlink associated with the at least one text-token when the object is recognized by wrapping the at least one text-token in the hyperlink according to a particular format.

2. The method of claim 1, wherein processing the stream of text to extract the at least one text-token comprises:
separating white space from the at least one text-token;
recording the at least one text-token in a first array and the white space in a second array; and
processing the at least one text-token in the first array to recognize the object.

3. The method of claim 2, wherein the object is maintained within a database that further includes a definition of a default action corresponding to the object and wherein processing the at least one text-token in the first array comprises accessing the database to identify the object.

4. The method of claim 2, further comprising:
reconstructing the stream of text by:
iterating through the first array and the second array to reassemble the stream of text with formatting in-place and the hyperlink associated with the at least one text-token.

5. The method of claim 1, wherein the object is at least one of a email address, a contact phone number, customer name, Internet Protocol version 4 address, Internet Protocol version 6 address, or an Autonomous System Number.

6. The method of claim 2, wherein the particular format is a fixed-pitch textual data format.

7. A system for generating hyperlinks comprising:
at least one processor to:
receive a stream of text from a network system corresponding to a telecommunication service provider;
process the stream of text to extract at least one text-token;
determine whether an object may be recognized from the at least one text-token; and
generate a hyperlink associated with the at least one text-token when the object is recognized by wrapping the at least one text-token in the hyperlink according to a particular format.

8. The system of claim 7, wherein to process the stream of text to extract the at least one text-token comprises:
separating white space from the at least one text-token;
recording the at least one text-token in a first array and the white space in a second array; and
processing the at least one text-token in the first array to recognize the object.

9. The system of claim 8, further comprising a database including the object and a definition of a default action corresponding to the object and wherein processing the at least one text-token in the first array comprises accessing the database to determine that the object exists.

10. The system of claim 8, wherein the particular format is a fixed-pitch textual data format.

11. The system of claim 8, wherein the at least one processor is further configured to reconstruct the stream of text by:
iterating through the first array and the second array to reassemble the stream of text with formatting in-place and the hyperlink associated with the at least one text-token.

12. The system of claim 7, wherein the object is at least one of a email address, a contact phone number, customer name, Internet Protocol version 4 address, Internet Protocol version 6 address, or an Autonomous System Number.

13. A non-transitory computer-readable medium encoded with instructions for generating hyperlinks, the instructions, executable by a processor, comprising:
receiving a stream of text from a network system corresponding to a telecommunication service provider;
processing the stream of text to extract at least one text-token;
determining whether an object may be recognized from the at least one text-token; and
generating a hyperlink associated with the at least one text-token when the object is recognized by wrapping the at least one text-token in the hyperlink according to a particular format.

14. The non-transitory computer-readable medium of claim 14, wherein processing the stream of text to extract the at least one text-token comprises:
separating white space from the at least one text-token;
recording the at least one text-token in a first array and the white space in a second array; and
processing the at least one text-token in the first array to recognize the object.

15. The non-transitory computer-readable medium of claim 14, wherein the object is maintained within a database that further includes a definition of a default action corresponding to the object and wherein processing the at least one text-token in the first array comprises accessing the database to identify the object.

16. The non-transitory computer-readable medium of claim 14, further comprising:
reconstructing the stream of text by:
iterating through the first array and the second array to reassemble the stream of text with formatting in-place and the hyperlink associated with the at least one text-token.

17. The non-transitory computer-readable medium of claim 14, wherein the object is at least one of a email address, a contact phone number, customer name, Internet Protocol version 4 address, Internet Protocol version 6 address, or an Autonomous System Number.

18. The non-transitory computer-readable medium of claim 14, wherein the particular format is a fixed-pitch textual data format.
